(19) United States
(12) Patent Application Publication
(10) Pub. No.: US 2018/0149524 A1
(43) Pub. Date: May 31, 2018

(54) System for protecting a thermocouple

(71) Applicant: Airbus Operations SAS, Toulouse (FR)

(72) Inventor: Yannick SOMMERER, CORNEBARRIEU (FR)

(21) Appl. No.: 15/824,119

(22) Filed: Nov. 28, 2017

(30) Foreign Application Priority Data
Nov. 29, 2016 (FR) 1661609

(51) Int. Cl. G01K 1/08; G01K 1/14; G01K 13/02; F01D 17/02

(52) U.S. Cl. CPC G01K 1/08; G01K 1/14; G01K 1/20; F01D 17/02; G01K 13/02

(57) ABSTRACT

A system for protecting a thermocouple placed in an environment comprising at least one radiative element, comprising a plate positioned between the thermocouple and the radiative element. The plate has an overall surface condition of an internal face facing towards the thermocouple such that the internal face absorbs radiation coming from the radiative element more than the internal face reflects the radiation.

### CROSS-REFERENCES TO RELATED APPLICATIONS

This application claims the benefit of the French patent application No. 1661609 filed on Nov. 29, 2016, the entire disclosures of which are incorporated herein by way of reference.

### BACKGROUND OF THE INVENTION

The present invention relates to the field of air temperature measurement by thermocouple in a highly radiative environment and more particularly to a system for protecting the thermocouple in such environments in order to optimize the performance thereof.

A thermocouple is an assembly of two wires of different metals joined at their ends so as to use the Seebeck effect to measure a temperature in a given medium. The Seebeck effect is a thermoelectrical effect brought about by a potential difference at the junction between two metals subjected to a temperature difference.

As shown by FIG. 1, the thermocouple 1 comprises two wires 2, 4 of different metals, joined together at one of their ends 6. This joint is referred to as the “hot junction”; and it is this junction that is placed in the environment the temperature T1 of which is to be measured. The two other ends 8a, 8b are connected to the terminals of a voltmeter 10; each of these two joints is referred to as “cold junction” and is at a temperature T2. The potential difference ΔV measured across the terminals of the voltmeter V 10 and brought about by the Seebeck effect is dependent on the difference in temperature between T1 and T2. The temperature T2 is a known temperature, for example that of the ambient air, or even that measured by a temperature sensor, for example of the thermoresistive type.

Now, it may be that, in the environment of which the temperature T1 is to be measured, there is a radiative heat transfer, for example with one or more walls that may be nearby, a conductive heat transfer with the metal wires of the thermocouple, and/or a convective heat transfer with the surrounding air. In order to measure the temperature T1 accurately, it is necessary for the conductive and radiative heat transfer thermal resistances to be high in comparison with the convective heat transfer thermal resistance.

What we are concerned with here is the radiative heat transfers. When the thermocouple is placed inside an enclosed space that has at least one extremely hot wall, the radiative heat flux reflected off the wall towards the thermocouple becomes problematical for obtaining a correct air temperature measurement. The equilibrium temperature of the thermocouple is closer to the true temperature of the air if the convective heat transfer thermal resistance is low in comparison with the radiative heat transfer thermal resistance.

The remainder of the description will focus on exemplary embodiments in the field of temperature measurement in an aircraft turbomachine engine compartment. The thermocouple is installed in the engine compartment of a bypass turbomachine. Now, one of the walls of the engine compartment on the interior side is heated by a primary flow of hot air coming from the compressor and from the combustion chamber of the turbomachine. Thus, the wall of the compartment on the primary-flow side is exposed to very high temperatures generating a great deal of thermal radiation that is enough to disturb the accuracy of the air temperature measured by operation of the thermocouple.

In addition, even though the engine compartment is ventilated, the air speeds observed are generally low, making the convective heat transfer thermal resistance not insignificant in comparison with the radiative heat transfer thermal resistance.

It is an object of the present invention to propose a device affording protection against the radiation that disturbs the operation of the thermocouple and to thus alleviate the problem of the proximity of a radiative wall in the example of an engine compartment or more generally.

### SUMMARY OF THE INVENTION

In order to do this, the present invention relates to a system for protecting a thermocouple placed in an environment comprising at least one radiative element, characterized in that it comprises a plate positioned between the thermocouple and a radiative element, the plate having an overall surface condition of its internal face facing towards the thermocouple that is such that the face absorbs the radiation coming from the element more than it reflects same.

The present invention thus makes it possible to protect the thermocouple from the radiative element that disrupts its operation. The fact that that face of the plate that faces the thermocouple absorbs more than it reflects, makes it possible to reduce the radiative heat flux reflected off the plate towards the thermocouple.

The protection system has at least one of the following optional features, considered alone or in combination.

The plate has an overall surface condition of its external face, the opposite face to the one that faces towards the thermocouple, such that the face reflects the radiation coming from the element more than the face absorbs same.

The internal face of the plate has a different overall surface condition from the external face of the plate that is the opposite face to the internal face.

The internal face of the plate facing towards the thermocouple has a reflectivity lower than that of the opposite face to the internal face.

The internal face of the plate is painted with a matt paint that improves the capacity of the plate to absorb.

The external face of the plate, that is the opposite face to the internal face, is polished.

The present invention also relates to an aircraft engine comprising a compartment one of the walls of which is situated in an environment, the temperature of which is higher than in the rest of the environment, characterized in that a thermocouple is installed in the compartment and in that a plate is positioned between the thermocouple and the wall, the plate having an overall surface condition of its internal face facing towards the thermocouple that is such that the face absorbs the radiation coming from the wall more than the face reflects same.

The engine has at least one of the following optional features, considered alone or in combination.

The plate has an overall surface condition of its external face, the opposite face to the one that faces towards the thermocouple, such that the face reflects the radiation coming from the element more than the face absorbs same.

The internal face of the plate has a different overall surface condition from the external face of the plate that is the opposite face to the internal face.

The present invention also relates to an aircraft comprising an engine having the above features considered alone or in combination.

### BRIEF DESCRIPTION OF THE DRAWINGS

Further objects, advantages and features of the invention will become apparent from reading the following description of a protection system according to the invention, given by way of nonlimiting example and with reference to the attached drawings in which:

FIG. 1 is a simplified schematic view of a thermocouple;

FIG. 2 is a simplified schematic view in lateral section of one embodiment of a thermocouple protection system according to the present invention;

FIG. 3 is a schematic view in cross section of a bypass turbomachine to which the protection system according to the invention may be applied;

FIG. 4 is a simplified schematic view in lateral section of another embodiment of the thermocouple protection system according to the present invention.

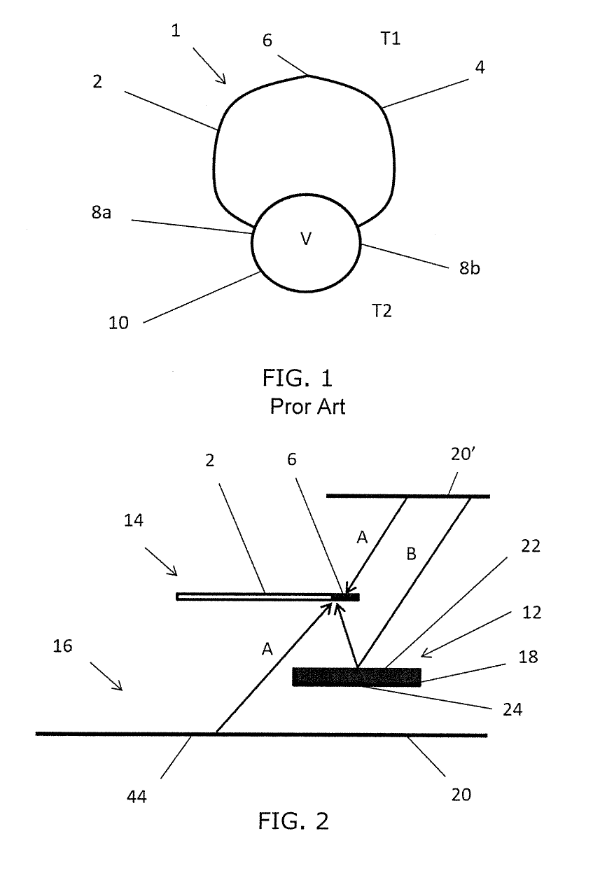

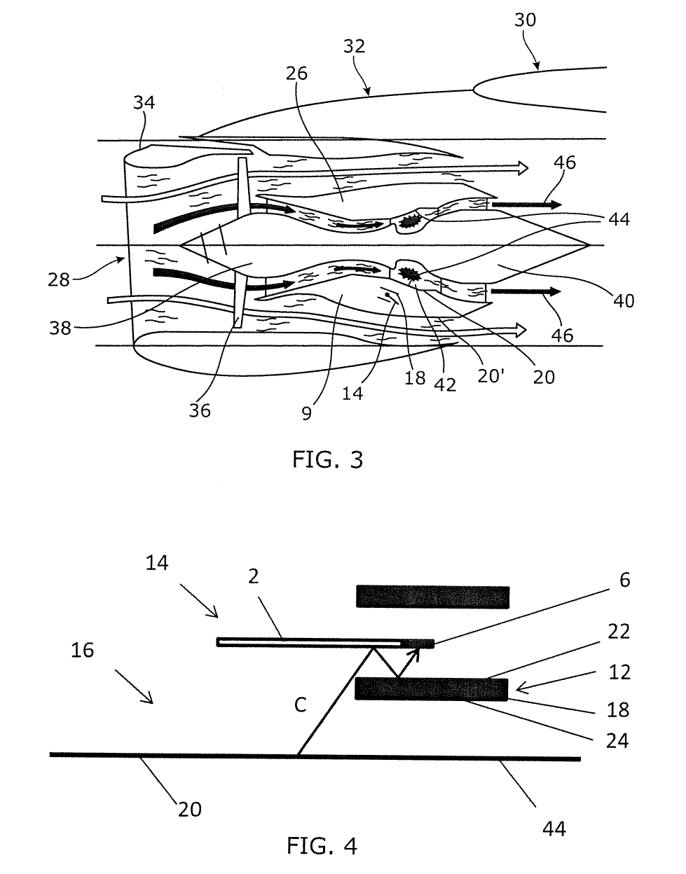

### DETAILED DESCRIPTION OF THE PREFERRED EMBODIMENTS

The present invention relates to a system for protecting a thermocouple 14 against disturbing heat exchanges and, more particularly, against the radiation of an environment 16 in which the thermocouple is placed.

The thermocouple protection system comprises a protection device 12 which takes the form of a plate 18. The plate 18 adopts any type of shape, for example planar, curved or with complex geometry. The plate 18 is positioned between the thermocouple 14 and a radiative element 20 such as, for example, a radiative wall 20 of the environment 16. The environment 16 may comprise other radiative elements 20′, such as, for example, in FIG. 2, another wall 20′ positioned on the opposite side of the thermocouple 14 to the wall 20. The radiation may be direct as illustrated for example by the radiation off the walls 20, 20′ onto the thermocouple as depicted by the arrow A in FIG. 2, or indirect, as illustrated for example by the radiation off the wall 20′ onto the thermocouple after having been reflected off the plate 18, as represented by the arrow B. The plate 18 has two faces 22, 24, an internal face 22 facing towards the thermocouple and, in the embodiment illustrated, towards the radiative element 20′, and an external face 24 facing in the opposite direction and, in the embodiment illustrated, facing towards the radiative wall 20.

The physical nature (conductive or otherwise . . . ) of the surface, the surface condition (flatness defects, cleanliness, roughness . . . ), the chemical surface condition (paint, oxidation . . . ) of the internal face 22 of the plate 18, are chosen so that the face 22 absorbs more than it reflects. The collection of these properties (physical nature, surface condition, chemical condition) will, in what follows, be termed “the overall surface condition.” The internal face 22 of the plate has a reflectivity at least below 0.5. More than half of the received heat flux is absorbed. In this way, the plate 18 limits the radiative heat flux reflected and directed towards the thermocouple 14, so as not to disrupt the operation thereof. The radiation is to a large extent, and more specifically predominantly, absorbed because more than 50% of the radiation is absorbed by the plate 18. Reflections off the plate 18 are limited, so as to avoid the plate 18 reflecting the radiation from the radiative element in the environment 16 towards the thermocouple 14.

The surface of the face 22 of the plate is produced, treated, worked and/or coated with a special composition in order to give it the desired properties, namely those described hereinabove.

Thus, the internal face 22 may, for example, be coated with a special matt paint that makes it possible to increase its capacity to absorb radiation.

The plate 18 has an external face 24, the opposite face to the internal face 22, and the overall surface condition of which allows it to reflect more than it absorbs. The external face 24 of the plate has a reflectivity at least higher than 0.5. More than half of the heat flux received is reflected. The radiation is, to a large extent, and more specifically predominantly, reflected because more than 50% of the radiation is reflected by the plate 18. In this way, the plate 18 limits the absorption of the radiative heat flux of the radiative element 20 so as to minimize the temperature of the plate. The greater the reflectivity of the external face 24, the more the plate temperature drops. The closer the temperature of the plate 18 is to the ambient air, the more accurate the temperature measured by the thermocouple and the smaller the error.

The surface of the face 24 of the plate is produced, treated, worked and/or coated with a special composition so that its properties are as desired, namely those described hereinabove.

Thus, the external face 24 may for example be polished to make its surface bright. A bright surface has greater reflectivity than the same surface in an unpolished condition.

The plate 18 has an overall surface condition of its internal face 22 that differs from that of its external face 24. The internal face 22 has a reflectivity lower than that of the external face 24. In order to obtain a plate that has two opposite faces 22, 24 with different surface conditions and, more particularly, different reflectivities, there are a number of possible solutions.

A first solution is to select a plate, the overall surface condition of at least one of the faces 22 and/or 24 of which is modified. It is possible to envisage a plate, one of the faces of which already has the required properties: all that is then required is for the surface condition of the other face to be modified. It is also possible to modify or even just enhance the surface condition of both faces 22 and 24.

In order to do this, as seen earlier, it is possible to produce the plate with the desired faces or alternatively to treat the surface of a plate in different ways (oxidation, . . . ), mechanically work it (polishing, machining, . . . ), apply a coating to it (metallization, paint, . . . ) which affords or just improves the surface properties of the plate in the desired direction.

A second solution is to assemble at least two plates, each respectively having a free face and a connecting face. The respective connecting faces are connected by any known means according to the material selected for the plate and each of the free faces has an overall surface condition that differs the one from the other. According to one particular embodiment, the connecting faces are disjointed, so that an air gap increases the insulation between the faces 22 and 24 and thus makes it possible to reduce the temperature of the face 22. The overall surface condition of one of the free faces corresponds to that of the internal face 22 and the overall surface condition of the other free face corresponds to that of the external face 24, described above. The device 12 may comprise more than two plates placed together: what is essential is to provide an overall surface condition for the free faces of the overall plate 18 formed that corresponds to that of the internal face 22 and of the external face 24 described above, respectively.

The description which follows sets out two exemplary embodiments in the field of aeronautics and, more particularly, of aircraft engines. The radiative environment is an engine compartment 26 of a bypass turbomachine 28 fixed to a wing 30 of an aircraft by a pylon 32. The turbomachine comprises a nacelle 34 which constitutes a casing, a fan 36, a compressor 38, a turbine 40 and one or more combustion chambers 42.

The engine compartment 26 of the turbomachine 28 is delimited by a casing. The interior wall 44 of the casing situated on the side of the hot primary air flow 46 is situated near the combustion chamber or chambers 42. The hot primary air flow 46 flows along the interior wall 44 of the casing. As seen above, the very high temperatures on the side of the wall 44 generates a great deal of thermal radiation which may disturb the thermocouple situated in the compartment 26.

According to a first embodiment, the one depicted in FIG. 2, a radiative element 20 is the interior wall 44 of the casing. The plate 18 is positioned between the interior wall 44 of the casing and the thermocouple 2 so as to protect the hot junction 6 from the radiative wall 44. The plate 18 is planar. The internal face 22 of the plate 18 has a greater capacity to absorb than to reflect, and the opposite is true of the external face 24. The faces 22 and 24 have the features set out in greater detail above.

According to a second embodiment depicted in FIG. 4, the plate 18 is of cylindrical shape. The plate 18 surrounds the hot junction 6 of the thermocouple. It is interposed between the interior wall 44 of the radiative casing and the thermocouple 2. In this way, it forms a barrier against direct radiation coming from the wall 44 and heading towards the hot junction 6. Only radiation reflected off the plate 18, as represented by the arrow C in FIG. 4, can reach the thermocouple. Now, the internal face 22 of the plate 28 has a greater capacity to absorb than to reflect and the opposite is true of the external face 24. The faces 22 and 24 have the features set out in greater detail hereinabove.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for protecting a thermocouple placed in an environment comprising at least one radiative element, comprising:
a plate positioned between the thermocouple and the radiative element, the plate having an overall surface condition of an internal face facing towards the thermocouple such that the internal face absorbs radiation coming from the radiative element more than the internal face reflects the radiation.

2. The system for protecting a thermocouple according to claim 1, wherein the plate has an overall surface condition of an external face, an opposite face to the internal face that faces towards the thermocouple, such that the external face reflects the radiation coming from the element more than the external face absorbs the radiation.

3. The system for protecting a thermocouple according to claim 1, wherein the internal face of the plate has a different overall surface condition from an external face of the plate that is an opposite face to the internal face.

4. The system for protecting a thermocouple according to claim 1, wherein the internal face of the plate facing towards the thermocouple has a reflectivity lower than that of an external face of the plate that is an opposite face to the internal face.

5. The system for protecting a thermocouple according to claim 1, wherein the internal face of the plate is painted with a matt paint that improves the capacity of the plate to absorb.

6. The system for protecting a thermocouple according to claim 2, wherein the external face of the plate is polished.

7. An aircraft engine comprising:
a compartment defined by walls, one of the walls of the compartment being situated in a part of an environment, the temperature of which is higher than in a remainder of the environment,
a thermocouple installed in the compartment, and
a plate positioned between the thermocouple and the one wall, the plate having an overall surface condition of an internal face facing towards the thermocouple such that the internal face absorbs radiation coming from the one wall more than the internal face reflects the radiation.

8. The aircraft engine according to claim 7, wherein the plate has an overall surface condition of an external face, a face opposite to the internal face that faces towards the thermocouple, such that the external face reflects the radiation coming from the one wall more than the external face absorbs the radiation.

9. The aircraft engine according to claim 7, wherein the internal face of the plate has a different overall surface condition from an overall surface condition of an external face of the plate, a face opposite to the internal face.

10. An aircraft comprising an engine according to claim 7.
